(19) United States
(12) Patent Application Publication
(10) Pub. No.: US 2021/0089825 A1
(43) Pub. Date: Mar. 25, 2021

(54) SYSTEMS AND METHODS FOR CLEANING DATA

(71) Applicant: BEIJING DIDI INFINITY TECHNOLOGY AND DEVELOPMENT CO., LTD., Beijing (CN)

(72) Inventors: Haifeng SHEN, Beijing (CN); Yan WANG, Beijing (CN)

(73) Assignee: BEIJING DIDI INFINITY TECHNOLOGY AND DEVELOPMENT CO., LTD., Beijing (CN)

(21) Appl. No.: 17/111,534

(22) Filed: Dec. 4, 2020

Related U.S. Application Data
(63) Continuation of application No. PCT/CN2018/090144, filed on Jun. 6, 2018.

(51) Int. Cl. G06K 9/62; G06K 9/68; G06K 9/00; G06N 3/04

(52) U.S. Cl. CPC G06K 9/6256; G06K 9/6814; G06N 3/04; G06K 9/00288; G06K 9/626

(57) ABSTRACT

A system may determine first groups of image data from multiple groups, obtain a first identification model based on the first groups of image data, and classify the first groups of image data to generate a first classification result based on the first identification model in which the first groups of image data may be classified into a qualified dataset and an unqualified dataset. The system may obtain an initial second identification model with a second accuracy threshold and perform one or more iterations. In each of one or more iterations, the system may classify the unqualified dataset to generate a second classification result, update the qualified dataset and the unqualified dataset, and update, based on the updated qualified dataset, the second identification model. The system may further determine the cleaned dataset based on the updated qualified dataset.

### CROSS-REFERENCE TO RELATED APPLICATIONS

This application is a continuation of International Application No. PCT/CN2018/090144 filed on Jun. 6, 2018, the entire contents of which are hereby incorporated by reference.

### TECHNICAL FIELD

This disclosure generally relates to face recognition systems, and more specifically relates to systems and methods for cleaning data to be used in face recognition.

### BACKGROUND

Neural network has greatly promoted the development of face recognition technology, which in turn expands the use of face recognition technology. The neural network used for face recognition needs to be trained using face data, which needs a large number of face images. At present, face images in a face database are mostly collected through the network. The quality of the face images may be uneven. For example, some pictures may be blurry, which leads to the face features cannot be identified precisely. In some embodiments, some person's pictures may be mistaken for another person. In addition, the data size associated with each person may be uneven. Therefore, it is desirable to develop systems and methods to clean data to provide cleaned data with a certain accuracy.

### SUMMARY

According to an aspect of the present disclosure, a system for interacting with a data providing system and a service providing system is provided. The system may include a data exchange port of the system to receive one or more datasets from the data providing system and one or more identification models from the service providing system, a data transmitting port of the system connected to the data providing system and the service providing system for conducting content identification, one or more storage devices, and at least one processor in communication with the data exchange port, the data transmitting port, and the one or more storage devices. The one or more storage devices may include a set of instructions for data cleaning. When the at least one processor executes the set of instructions, the system may be directed to perform one or more of the following operations. The one or more processors may obtain a data cleaning request and a dataset including multiple groups of image data from the data providing system, and determine first groups of image data from the multiple groups. Each of the first groups of image data may associated with a characteristic of a first subject. The one or more processors may also obtain a first identification model configured with a first accuracy threshold based on the first groups of image data and classify the first groups of image data to generate a first classification result based on the first identification model. Each of the first groups of image data may classified into a first part and/or a second part. Image data in the first part may correspond to a first subject with a first probability greater than the first accuracy threshold, and image data in the second part may correspond to the first subject with a second probability lower than the first accuracy threshold. The first parts of the first groups may constitute a qualified dataset, and the second parts of the first groups may constitute an unqualified dataset. The one or more processors may obtain an initial second identification model with a second accuracy threshold based on the image data in the qualified dataset. The one or more processors may perform one or more iterations. In each of one or more iterations, the one or more processors may classify, based on a second identification model, the unqualified dataset to generate a second classification result that identifies a portion of the second parts of the first groups to be incorporated into the qualified dataset, update the qualified dataset and the unqualified dataset based on the second classification result, and update, based on the updated qualified dataset, the second identification model. The second identification model may be the initial second identification model or an updated second identification model determined in a prior iteration. The one or more processors may further determine the cleaned dataset based on the updated qualified dataset or the updated second identification model to be provided to the data providing system.

In some embodiments, the one or more processors may further obtain a third identification model from the service providing system and identify, based on the third identification model, a fraction of the dataset to be removed. The identified fraction may include image data that fail to specify the characteristic of a first subject. The one or more processors may pre-clean the dataset based on the third identification model by removing the identified fraction of the dataset.

In some embodiments, a data size of each of the one or more first groups exceeds a first threshold.

In some embodiments, to obtain a first identification model with a first accuracy threshold, the one or more processors may generate the first identification model by training a fourth identification model using the first groups of image data.

In some embodiments, the fourth identification model may be constructed based on a neural network model.

In some embodiments, to obtain an initial second identification model with a second accuracy threshold, the one or more processors may generate the initial second identification model by training the first identification model using the qualified dataset.

In some embodiments, to classify the unqualified dataset, the one or more processors may determine, based on the second identification model, whether a third probability that the image data in the second part of a first group correspond to a target first subject exceeds the second accuracy threshold.

In some embodiments, to determine whether a third probability that the image data in the second part of a first group correspond to a target first subject exceeds the second accuracy threshold, the one or more processors may determine, based on the second identification model, an estimated feature represented in the image data in the second part. The estimated feature being associated with the characteristic of the first subject. The one or more processors may determine, based on the second identification model, a reference feature associated with each of one or more candidate first subjects, the reference feature being associated with the characteristic of the first subject. The one or more processors may further determine, based on the estimated feature and the one or more reference features, the target first subject from the one or more candidate first subjects. The one or more processors may also determine the third probability and compare the third probability with the second accuracy threshold.

In some embodiments, to determine one or more reference features associated with one or more candidate first subjects, for each of the one or more candidates first subject, the one or more processors may determine, based one or more images in the first part of the each candidate first subject, a set of features associated with the each candidate first subject using the second identification model. The one or more processors may determine an equalization feature based on the set of features and designate the equalization feature as the reference feature associated with the each candidate first subject.

In some embodiments, to determine whether a third probability that the image data in the second part of a first group corresponds to the target first subject exceeds the second accuracy threshold, the one or more processors may determine a similarity between the reference feature and the target first subject and determine whether the similarity exceeds a second threshold. The one or more processors may further determine that the third probability exceeds the second accuracy threshold if the similarity exceeds the second threshold.

In some embodiments, to classify the unqualified dataset to generate a second classification result, for each second part of the second parts of the first groups, the one or more processors may determine, based on the second identification model, the third probability that the image data in the second part of a first group correspond to a target first subject exceeds the second accuracy threshold. In response to a determination that the third probability of the second part exceeds the second accuracy threshold, the one or more processors may incorporate the image data in the second part into the first part of the first group corresponding to the target first subject.

In some embodiments, to classify the unqualified dataset to generate a second classification result, for each second part of the second parts of the first groups, the one or more processors may determine, based on the second identification model, that the third probability that the image data in the second part of a first group correspond to a target first subject is below the second accuracy threshold. In response to a determination that the third probability of the second part is below the third threshold, the one or more processors may retain the image data in the second part in the unqualified dataset.

In some embodiments, the one or more processors may further determine one or more second groups from the multiple groups. A data size of each of the one or more second groups may be below a third threshold. Each of the one or more second groups may be associated with a second subject. the one or more processors may also classify, based on the updated second identification model, the updated unqualified dataset to generate a third classification result that identifies a portion of the unqualified dataset to be incorporated into the second groups. The one or more processors may further update, based on the third classification result, the one or more second groups; and determine the cleaned dataset including the qualified dataset and the updated second groups.

According to another aspect of the present disclosure, a method for data cleaning is provided. The method may be implemented on a computing device having at least one processor, at least one storage medium, and a communication platform connected to a network. The method may include obtaining a data cleaning request and a dataset including multiple groups of image data from a data providing system, and determine first groups of image data from the multiple groups. Each of the first groups of image data may associated with a characteristic of a first subject. The method may also include obtaining a first identification model configured with a first accuracy threshold based on the first groups of image data and classifying the first groups of image data to generate a first classification result based on the first identification model. Each of the first groups of image data may classified into a first part and/or a second part. Image data in the first part may correspond to a first subject with a first probability greater than the first accuracy threshold, and image data in the second part may correspond to the first subject with a second probability lower than the first accuracy threshold. The first parts of the first groups may constitute a qualified dataset, and the second parts of the first groups may constitute an unqualified dataset. The method may include obtaining an initial second identification model with a second accuracy threshold based on the image data in the qualified dataset. The method may include performing one or more iterations. In each of one or more iterations, the method may include classifying, based on a second identification model, the unqualified dataset to generate a second classification result that identifies a portion of the second parts of the first groups to be incorporated into the qualified dataset, updating the qualified dataset and the unqualified dataset based on the second classification result, and updating, based on the updated qualified dataset, the second identification model. The second identification model may be the initial second identification model or an updated second identification model determined in a prior iteration. The method may further include determining the cleaned dataset based on the updated qualified dataset or the updated second identification model to be provided to the data providing system.

According to a further aspect of the present disclosure, a non-transitory computer readable medium is provided. The non-transitory computer readable medium may include a set of instructions for determining parent-child relationships. When the at least one processor executes the set of instructions, the at least one processor may be directed to perform one or more of the following operations. The one or more processors may obtain a data cleaning request and a dataset including multiple groups of image data from a data providing system, and determine first groups of image data from the multiple groups. Each of the first groups of image data may associated with a characteristic of a first subject. The one or more processors may also obtain a first identification model configured with a first accuracy threshold based on the first groups of image data and classify the first groups of image data to generate a first classification result based on the first identification model. Each of the first groups of image data may classified into a first part and/or a second part. Image data in the first part may correspond to a first subject with a first probability greater than the first accuracy threshold, and image data in the second part may correspond to the first subject with a second probability lower than the first accuracy threshold. The first parts of the first groups may constitute a qualified dataset, and the second parts of the first groups may constitute an unqualified dataset. The one or more processors may obtain an initial second identification model with a second accuracy threshold based on the image data in the qualified dataset. The one or more processors may perform one or more iterations. In each of one or more iterations, the one or more processors may classify, based on a second identification model, the unqualified dataset to generate a second classification result that identifies a portion of the second parts of the first groups to be incorporated into the qualified dataset, update the qualified dataset and the unqualified dataset based on the second classification result, and update, based on the updated qualified dataset, the second identification model. The second identification model may be the initial second identification model or an updated second identification model determined in a prior iteration. The one or more processors may further determine the cleaned dataset based on the updated qualified dataset or the updated second identification model to be provided to the data providing system.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a schematic diagram illustrating an exemplary data cleaning system according to some embodiments of the present disclosure;

FIG. 2 is a schematic diagram illustrating exemplary components of a computing device according to some embodiments of the present disclosure;

FIG. 3 is a schematic diagram illustrating exemplary hardware and/or software components of an exemplary user terminal according to some embodiments of the present disclosure;

FIG. 4 is a block diagram illustrating an exemplary processing device according to some embodiments of the present disclosure;

FIG. 5 is a block diagram illustrating an exemplary data cleaning module according to some embodiments of the present disclosure;

FIG. 6 is a flowchart illustrating an exemplary process for cleaning a dataset according to some embodiments of the present disclosure e;

FIG. 7 is a flowchart illustrating an exemplary process for classifying a dataset based on data size according to some embodiments of the present disclosure;

FIG. 8 is a flowchart illustrating an exemplary process for classifying at least one portion of a dataset according to some embodiments of the present disclosure;

FIG. 9 is a flowchart illustrating an exemplary process for classifying image data based on features according to some embodiments of the present disclosure; and

FIG. 10 is a flowchart illustrating an exemplary process for classifying at least one portion of a dataset according to some embodiments of the present disclosure.

### DETAILED DESCRIPTION

In order to illustrate the technical solutions related to the embodiments of the present disclosure, brief introduction of the drawings referred to in the description of the embodiments is provided below. Obviously, drawings described below are only some examples or embodiments of the present disclosure. Those having ordinary skills in the art, without further creative efforts, may apply the present disclosure to other similar scenarios according to these drawings. Unless stated otherwise or obvious from the context, the same reference numeral in the drawings refers to the same structure and operation.

As used in the disclosure and the appended claims, the singular forms “a,” “an,” and “the” include plural referents unless the content clearly dictates otherwise. It will be further understood that the terms “comprises,” “comprising,” “includes,” and/or “including” when used in the disclosure, specify the presence of stated steps and elements, but do not preclude the presence or addition of one or more other steps and elements.

Some modules of the system may be referred to in various ways according to some embodiments of the present disclosure, however, any number of different modules may be used and operated in a client terminal and/or a server. These modules are intended to be illustrative, not intended to limit the scope of the present disclosure. Different modules may be used in different aspects of the system and method.

According to some embodiments of the present disclosure, flow charts are used to illustrate the operations performed by the system. It is to be expressly understood, the operations above or below may or may not be implemented in order. Conversely, the operations may be performed in inverted order, or simultaneously. Besides, one or more other operations may be added to the flowcharts, or one or more operations may be omitted from the flowchart.

Technical solutions of the embodiments of the present disclosure be described with reference to the drawings as described below. It is obvious that the described embodiments are not exhaustive and are not limiting. Other embodiments obtained, based on the embodiments set forth in the present disclosure, by those with ordinary skill in the art without any creative works are within the scope of the present disclosure.

Some embodiments of the present disclosure relate to systems and methods for data cleaning. The system may obtain a data cleaning request and a dataset from a data providing system. The dataset may include multiple groups of image data. In response to the data cleaning request of the data providing system, the system may determine first groups of image data from the multiple groups. Each of the first groups of image data may be associated with a characteristic of a first subject. The system may obtain, based on the first groups of image data, a first identification model configured with a first accuracy threshold and classify, based on the first identification model, the first groups of image data to generate a first classification result in which each of the first groups of image data is classified into a first part and/or a second part. Image data in the first part may correspond to a first subject with a first probability greater than the first accuracy threshold, and image data in the second part may correspond to the first subject with a second probability lower than the first accuracy threshold. The first parts of the first groups may constitute a qualified dataset and the second parts of the first groups may constitute an unqualified dataset. The system may obtain, based on the image data in the qualified dataset, a second identification model with a second accuracy threshold and perform one or more iterations. In each of one or more iterations, the system may classify, based on the second identification model, the unqualified dataset image data in the second parts of the first groups to generate a second classification result that identifies a portion of the second parts of the first groups to be incorporated into the qualified dataset, update the qualified dataset and the unqualified dataset based on the second classification result, and update, based on the updated qualified dataset, the second identification model. The system may determine the cleaned dataset based on the updated qualified dataset or the updated second identification model to be provided to the data providing system.

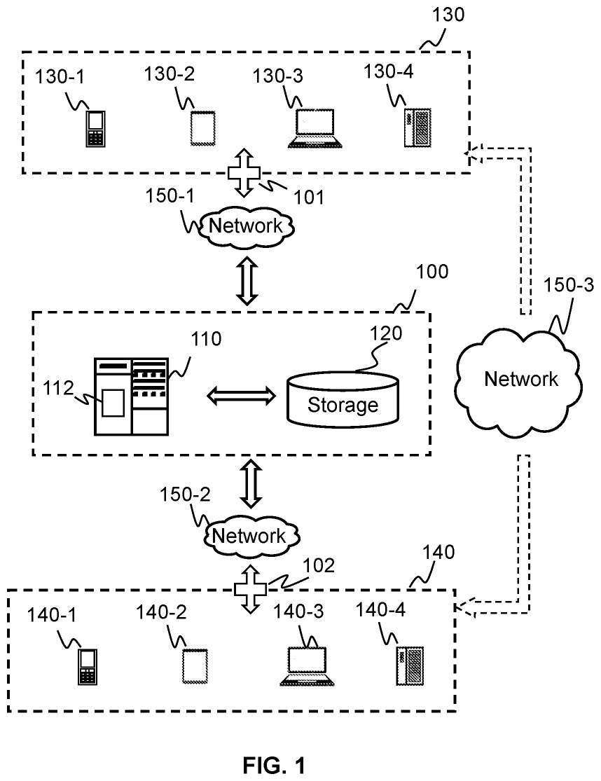

FIG. 1 is a schematic diagram illustrating an exemplary data cleaning system according to some embodiments of the present disclosure. The data cleaning system may be a platform for data and/or information processing, for example, training an identification model for content identification and/or data classification, such as image classification, text classification, etc. The data cleaning system may include a data exchange port 101, a data transmitting port 102, a server 110, and storage 120. The server 110 may include a processing device 112. In some embodiments, the data cleaning system may interact with a data providing system 130 and a service providing system 140 via the data exchange port 101 and the data transmitting port 102, respectively. For example, data cleaning system may access information and/or data stored in the data providing system 130 via the data exchange port 101. As another example, the server 110 may send information and/or data to a service providing system 140 via the data transmitting port 102.

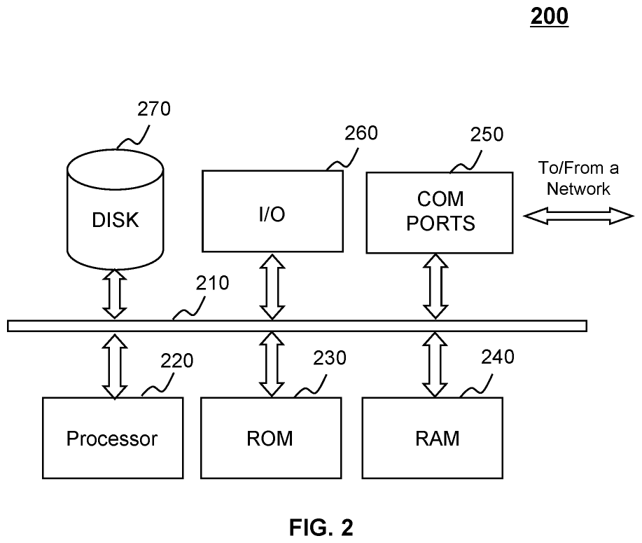

The server 110 may process information and/or data relating to content identification and/or data classification. For example, the server 110 may receive a dataset from a data providing system 130, and clean the dataset to provide the cleaned dataset to the data providing system 130 or the service providing system 140. As another example, the server 110 may clean the dataset by classifying the dataset based on one or more identification models. In some embodiments, the server 110 may be a single server, or a server group. The server group may be centralized, or distributed (e.g., the server 110 may be a distributed system). In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device having one or more components illustrated in FIG. 2 in the present disclosure.

In some embodiments, the server 110 may include a processing device 112. The processing device 112 may process information and/or data relating to content identification and/or data classification to perform one or more functions described in the present disclosure. For example, the processing device 112 may obtain one or more image datasets from the data providing system 130, and train an identification model for classifying images into multiple groups for various uses including, e.g., model training, model testing, etc. In some embodiments, the processing device 112 may include one or more processing engines (e.g., single-core processing engine(s) or multi-core processor(s)). Merely by way of example, the processing device 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The storage 120 may store data and/or instructions related to content identification and/or data classification. In some embodiments, the storage 120 may store data obtained/acquired from the data providing system 130 and/or the service providing system 140. In some embodiments, the storage 120 may store data and/or instructions that the server 110 may execute or use to perform exemplary methods described in the present disclosure. In some embodiments, the storage 120 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (PEROM), an electrically erasable programmable ROM (EEPROM), a compact disk ROM (CD-ROM), and a digital versatile disk ROM, etc. In some embodiments, the storage 120 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage 120 may be connected to or communicate with the server 110. The server 110 may access data or instructions stored in the storage 120 directly or via a network. In some embodiments, the storage 120 may be a part of the server 110.

The data providing system 130 may provide data and/or information related to content identification and/or data classification. The data and/or information may include images, text files, voice segments, web pages, video recordings, user requests, programs, applications, algorithms, instructions, computer codes, or the like, or a combination thereof. In some embodiments, the data providing system 130 may provide the data and/or information to the server 110 and/or the storage 120 of the data cleaning system for processing (e.g., train an identification model, classify a dataset, etc.). In some embodiments, the data providing system 130 may provide the data and/or information to the service providing system 140 for generating a service response relating to the content identification and/or data classification.

In some embodiments, the service providing system 140 may be configured to provide online services, such as a content identification service (e.g., a face identification service, a fingerprint identification service, a speech identification service, a text identification service, an image identification service, etc.), an online to offline service (e.g., a taxi service, a carpooling service, a food delivery service, a party organization service, an express service, etc.), an unmanned driving service, a medical service, a map-based service (e.g., a route planning service), a live chatting service, a query service, a Q&A service, etc. The service providing system 140 may generate service responses, for example, by inputting the data and/or information received from a user and/or the data providing system 130 into a trained identification model.

In some embodiments, the data providing system 130 and/or the service providing system 140 may be a device, a platform, or other entity interacting with the data cleaning system. In some embodiments, the data providing system 130 may be implemented in a device with data acquisition and/or data storage, such as a mobile device 130-1, a tablet computer 130-2, a laptop computer 130-3, and a server 130-4, a storage device (not shown), or the like, or any combination thereof. In some embodiments, the service providing system 140 may also be implemented in a device with data processing, such as a mobile device 140-1, a tablet computer 140-2, a laptop computer 140-3, and a server 140-4, or the like, or any combination thereof. In some embodiments, the mobile devices 130-1 and 140-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistant (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass, an Oculus Rift, a HoloLens, a Gear VR, etc. In some embodiments, the servers 130-4 and 140-4 may include a database server, a file server, a mail server, a web server, an application server, a computing server, a media server, a communication server, etc.

In some embodiments, the data providing system 130 may be a device with data processing technology for preprocessing acquired or stored information (e.g., identifying images from stored information). In some embodiments, the service providing system 140 may be a device for data processing, for example, train an identification model using a cleaned dataset received from the server 110. In some embodiments, the service providing system 140 may directly communicate with the data providing system 130 via a network 150-3. For example, the service providing system 140 may receive a dataset from the data providing system 130, and identify the contents using a trained identification model.

In some embodiments, any two systems of the data cleaning system 100, the data providing system 130, and the service providing system 140 may be integrated into a device or a platform. For example, both the data providing system 130 and the service providing system 140 may be implemented in a mobile device of a user. In some embodiments, the data cleaning system 100, the data providing system 130, and the service providing system 140 may be integrated into a device or a platform. For example, the data cleaning system 100, the data providing system 130, and the service providing system 140 may be implemented in a computing device including a server and a user interface.

Networks 150-1 through 150-3 may facilitate exchange of information and/or data. In some embodiments, one or more components in the data cleaning system (e.g., the server 110 and/or the storage 120) may send and/or receive information and/or data to/from the data providing system 130 and/or the service providing system 140 via the networks 150-1 through 150-3. For example, the server 110 may obtain/acquire datasets for cleaning from the data providing system 130 via the network 150-1. As another example, the server 110 may transmit/output the cleaned dataset to the service providing system 140 via the network 150-2. In some embodiments, the networks 150-1 through 150-3 may be any type of wired or wireless networks, or combination thereof. Merely by way of example, the networks 150 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth™ network, a ZigBee™ network, a near field communication (NFC) network, a global system for mobile communications (GSM) network, a code-division multiple access (CDMA) network, a time-division multiple access (TDMA) network, a general packet radio service (GPRS) network, an enhanced data rate for GSM evolution (EDGE) network, a wideband code division multiple access (WCDMA) network, a high speed downlink packet access (HSDPA) network, a long term evolution (LTE) network, a user datagram protocol (UDP) network, a transmission control protocol/Internet protocol (TCP/IP) network, a short message service (SMS) network, a wireless application protocol (WAP) network, a ultra wide band (UWB) network, an infrared ray, or the like, or any combination thereof.

FIG. 2 is a schematic diagram illustrating exemplary components of a computing device according to some embodiments of the present disclosure. The server 110, the storage 120, the data providing system 130, and/or the service providing system 140 may be implemented on the computing device 200 according to some embodiments of the present disclosure. The particular system may use a functional block diagram to explain the hardware platform containing one or more user interfaces. The computer may be a computer with general or specific functions. Both types of the computers may be configured to implement any particular system according to some embodiments of the present disclosure. Computing device 200 may be configured to implement any components that perform one or more functions disclosed in the present disclosure. For example, the computing device 200 may implement any component of the data cleaning system as described herein. In FIGS. 1 and 2, only one such computer device is shown purely for convenience purposes. One of ordinary skill in the art would understood at the time of filing of this application that the computer functions relating to the service as described herein may be implemented in a distributed fashion on a number of similar platforms, to distribute the processing load.

The computing device 200, for example, may include communication (COM) ports 250 connected to and from a network connected thereto to facilitate data communications. The computing device 200 may also include a processor (e.g., the processor 220), in the form of one or more processors (e.g., logic circuits), for executing program instructions. For example, the processor may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The exemplary computing device may include the internal communication bus 210, program storage and data storage of different forms including, for example, a disk 270, and a read only memory (ROM) 230, or a random access memory (RAM) 240, for various data files to be processed and/or transmitted by the computing device. The exemplary computing device may also include program instructions stored in the ROM 230, RAM 240, and/or other type of non-transitory storage medium to be executed by the processor 220. The methods and/or processes of the present disclosure may be implemented as the program instructions. The computing device 200 also includes an I/O component 260, supporting input/output between the computer and other components. The computing device 200 may also receive programming and data via network communications.

Merely for illustration, only one processor and/or processor is illustrated in FIG. 2. Multiple CPUs and/or processors are also contemplated; thus operations and/or method steps performed by one CPU and/or processor as described in the present disclosure may also be jointly or separately performed by the multiple CPUs and/or processors. For example, if in the present disclosure the CPU and/or processor of the computing device 200 executes both operation A and operation B, it should be understood that operation A and operation B may also be performed by two different CPUs and/or processors jointly or separately in the computing device 200 (e.g., the first processor executes operation A and the second processor executes operation B, or the first and second processors jointly execute operations A and B).

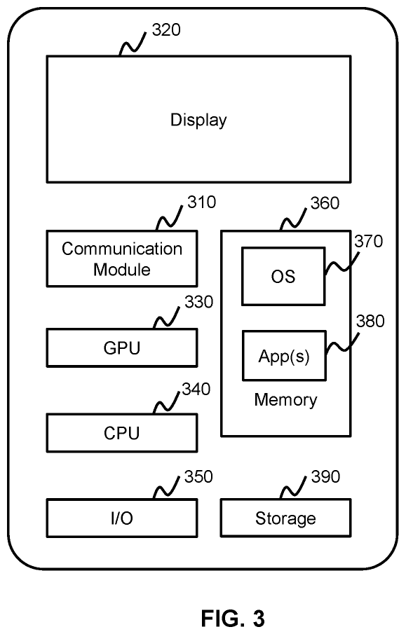

FIG. 3 is a block diagram illustrating exemplary hardware and/or software components of an exemplary requestor terminal according to some embodiments of the present disclosure. The data providing system 130 or the service providing system 140 may be implemented on the mobile device 300 according to some embodiments of the present disclosure. As illustrated in FIG. 3, the mobile device 300 may include a communication module 310, a display 320, a graphic processing unit (GPU) 330, a central processing unit (CPU) 340, an I/O 350, a memory 360, and storage 390. The CPU 340 may include interface circuits and processing circuits similar to the processor 220. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to a service request or other information from the data cleaning system on the mobile device 300. User interactions with the information stream may be achieved via the I/O devices 350 and provided to the processing device 112 and/or other components of the data cleaning system via the network 150.

In order to implement various modules, units and their functions described above, a computer hardware platform may be used as hardware platforms of one or more elements (e.g., a component of the sever 110 described in FIG. 1). Since these hardware elements, operating systems, and program languages are common, it may be assumed that persons skilled in the art may be familiar with these techniques and they may be able to provide information required in the data classification according to the techniques described in the present disclosure. A computer with user interface may be used as a personal computer (PC), or other types of workstations or terminal devices. After being properly programmed, a computer with user interface may be used as a server. It may be considered that those skilled in the art may also be familiar with such structures, programs, or general operations of this type of computer device. Thus, extra explanations are not described for the figures.

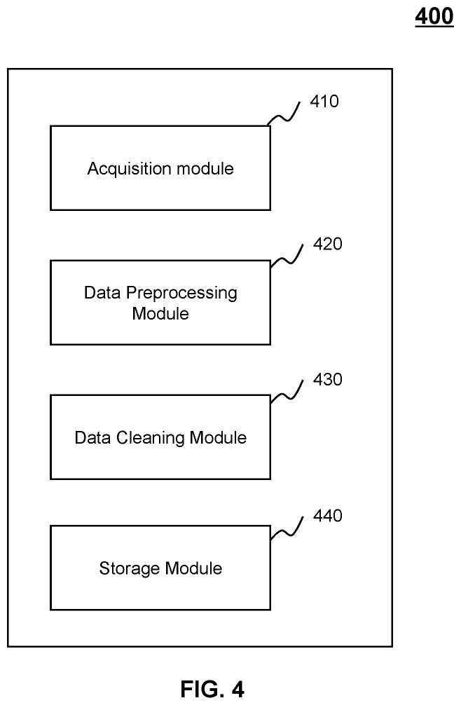

FIG. 4 is a block diagram illustrating an exemplary processing device 112 according to some embodiments of the present disclosure. The processing device 112 may include an acquisition module 410, a data preprocessing module 420, a data cleaning module 430, and a storage module 440. The modules may be hardware circuits of at least part of the processing device 112. The modules may also be implemented as an application or set of instructions read and executed by the processing device 112. Further, the modules may be any combination of the hardware circuits and the application/instructions. For example, the modules may be the part of the processing device 112 when the processing device 112 is executing the application/set of instructions.

The acquisition module 410 may obtain data and/or dataset from one or more components in the data cleaning system or interacting with the data cleaning system (e.g., the data providing system 130, the storage 120, the service providing system 140, etc.). The data may include image data associated with one or more subjects, models for face recognition, etc. The dataset may refer to multiple collections of data (e.g., images) associated with one or more subjects. Each of the multiple collections of data (e.g., images) may be associated with a subject. In some embodiments, the acquisition module 410 may obtain the data and/or the dataset from a database (e.g., a local database stored in the storage 120, or a remote database) via the networks 150-1 through 150-3. Exemplary database may include FERET database, MIT face database, Yale face database, PIE face database, ORL face database, etc. The acquisition module 410 may transmit the obtained data/dataset to other modules in the processing device 112 (e.g., the feature determination module 420) for further processing.

The data preprocessing module 420 may perform one or more preprocessing operations to preprocess the data and/or dataset. For example, the data preprocessing module 420 may pre-clean a dataset based on one or more identification models. Further the data preprocessing module 420 may identify a fraction of the dataset to be removed based on the third identification model. The identified fraction may include image data that fail to specify the characteristic of a subject.

The data cleaning module 430 may clean the dataset and/or the pre-cleaned dataset. In some embodiments, the dataset may include multiple groups of images. Each of the multiple groups may be associated with a subject. The image data in the each of the multiple groups may be pre-tagged with a label indicating the subject. The data cleaning module 430 may identify image data in the dataset with an inaccurate label and classify the image data with the inaccurate label into another group of the multiple groups or remove the image data from the dataset.

The storage module 440 may store information. The information may include programs, software, algorithms, data, text, number, images, models and some other information. For example, the information may include a dataset to be cleaned, an intermediate dataset and/or data for cleaning the dataset, or a combination thereof. In some embodiments, the storage module 508 may store program(s) and/or instruction(s) that can be executed by the processor(s) of the processing device 120 to acquire a dataset, and clean the dataset.

It should be noted that the above description of the processing device 112 is merely provided for the purposes of illustration, and not intended to limit the scope of the present disclosure. For persons having ordinary skills in the art, multiple variations and modifications may be made under the teachings of the present disclosure. For example, the data preprocessing module 420 and the data cleaning module 430 may be integrated into one single module. As another example, the storage module 440 may be integrated into any one of the components of the processing device 112 (e.g., the acquisition module 410, the data preprocessing module 420, and/or the data cleaning module 430). However, those variations and modifications do not depart from the scope of the present disclosure.

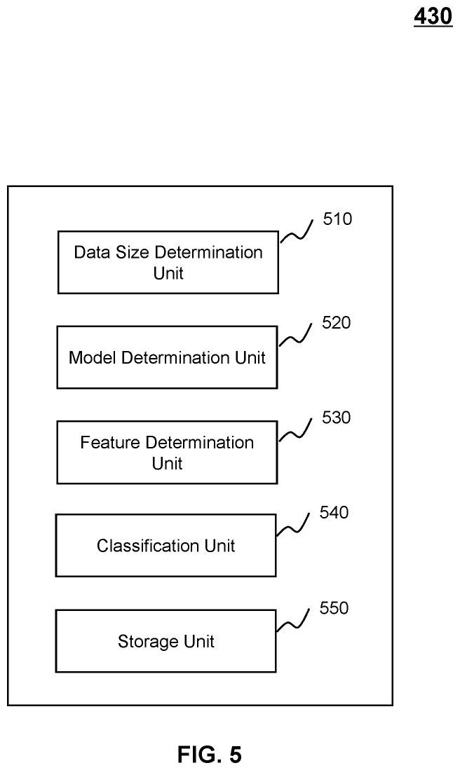

FIG. 5 is a block diagram illustrating an exemplary data cleaning module 430 according to some embodiments of the present disclosure. The data cleaning module 430 may include a data size determination unit 510, a model determination unit 520, a feature determination unit 530, a classification unit 540, and a storage unit 540. The units may be hardware circuits of at least part of the processing device 112. The units may also be implemented as an application or set of instructions read and executed by the processing device 112. Further, the units may be any combination of the hardware circuits and the application/instructions. For example, the units may be the part of the processing device 112 when the processing device 112 is executing the application/set of instructions.

The data size determination unit 510 may determine the data size of a group of image data. In some embodiments, a dataset may include multiple groups of image data. Each of the multiple groups may be associated with a subject. The data size determination unit 510 may determine the data size of at least one of the multiple groups in the dataset. As used herein, the data size of a group may refer to the number/count of images in the group. In some embodiments, the data size determination unit 510 may transfer the data size of each of the multiple groups in a dataset to one or more units of the data cleaning module 430. For example, the data size determination unit 510 may transfer the data size of each of the multiple groups in a dataset to the classification unit 540 for classifying the multiple groups according to data size.

The model determination unit 520 may determine one or more identification models. Exemplary identification models may include at least one of a Long Short-Term Memory (LSTM) model, a Recurrent Neural Network (RNN) model, a Convolutional Neural Network (CNN) model, or a Generative Adversative Nets (GAN) model, or the like, or any combination thereof. In some embodiments, the model determination unit 520 may determine a first identification model. The first identification model may be used to determine a probability for an image corresponding to a subject. The first identification model may be also used to classify the dataset into one or more groups. For example, the first identification model may be used to classify an image labeled with label A into a group A, and an image labeled with label B into a group B. In some embodiments, the model determination unit 520 may determine a second identification model. The second identification model may be used to determine one or more features from an image in the dataset. The model determination unit 520 may transfer the one or more identification models to one or more units of the data cleaning module 430. For example, the data size determination unit 510 may transfer the second identification model to the feature determination unit 530 for determining one or more features.

The feature determination unit 530 may determine one or more features from one or more images in the dataset. In some embodiments, the feature determination unit 530 may determine an estimated feature from images in an unqualified dataset. In some embodiments, the feature determination unit 530 may determine one or more reference feature from images in a qualified dataset. The model determination unit 520 may transfer the one or more features to one or more units of the data cleaning module 430. For example, the feature determination unit 530 may transfer the one or more features to the classification unit 540 for classifying the unqualified dataset.

The classification unit 540 may classify a dataset and/or intermediate data generating in a process for cleaning the dataset. In some embodiments, the classification unit 540 may classify a dataset into one or more first groups and one or more second groups according to the data size of each of the first groups and one or more second groups. In some embodiments, the classification unit 540 may classify the first groups based on a first identification model to generate a first classification result. The first classification result may include a first part and a second part for each of the first groups. The image data in the first part may correspond to a first subject with a first probability greater than a second threshold. The image data in the second part may correspond to the first subject with a second probability below the second threshold. The first parts of the first groups may constitute a qualified dataset, and the second parts of the first groups may constitute an unqualified dataset. In some embodiments, the data cleaning module 430 may classify the unqualified dataset by performing one or more iterations based on features. In each of the one or more iterations, the classification unit 540 may classify, based on a second identification model, the image data in the second parts of the first groups to generate a second classification result that identifies a portion of the second parts of the first groups to be incorporated into the qualified dataset. The classification unit 540 may update the qualified dataset and the unqualified dataset based on the second classification result in each of the one or more iterations. The classification unit 540 may further update the second identification model based on the updated qualified dataset. In some embodiments, the data cleaning module 430 may determine the cleaned dataset based on the updated qualified dataset or the updated second identification model to be provided to the data providing system 130 or the service providing system 140.

The storage module 440 may store data generated in a process for cleaning the dataset. The data generated in a process for cleaning the dataset may include an intermediate dataset (e.g., the first groups of image data, the second groups of image data, the unqualified dataset, the qualified dataset, etc.), probabilities, features, one or more identification models, or the like, or a combination thereof. In some embodiments, the storage module 508 may store program(s) and/or instruction(s) that can be executed by the processor(s) of the processing device 120 to acquire a dataset, and clean the dataset.

It should be noted that the above description of the model determination module 430 is merely provided for the purposes of illustration, and not intended to limit the scope of the present disclosure. For persons having ordinary skills in the art, multiple variations and modifications may be made under the teachings of the present disclosure. However, these variations and modifications still remain in the scope of the present disclosure. For example, the training set determining unit 510 and the perturbation unit 520 may be integrated into a single unit.

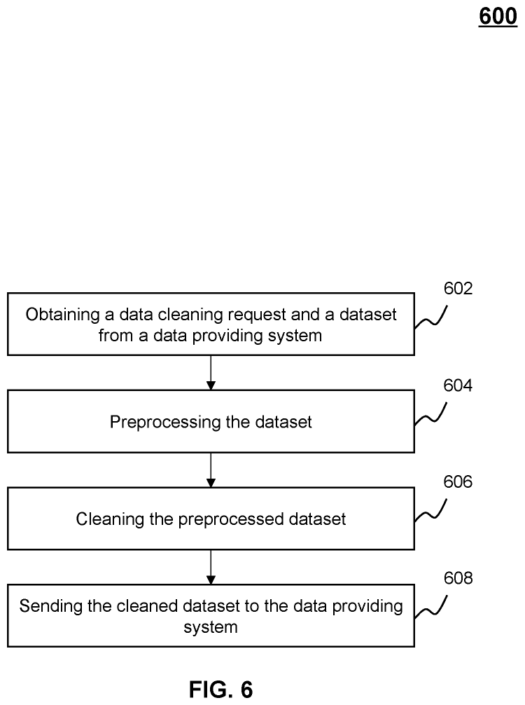

FIG. 6 is a flowchart illustrating an exemplary process for cleaning a dataset according to some embodiments of the present disclosure. In some embodiments, the process 600 may be implemented in the data cleaning system. For example, the process 600 may be stored in the storage 120 and/or the storage (e.g., the ROM 230, the RAM 240, etc.) as a form of instructions, and invoked and/or executed by the server 110 (e.g., the processing device 112 in the server 110, or the processor 220 of the processing device 112 in the server 110).

In 602, the processing device 112 (e.g., the acquisition module 410) may obtain a data cleaning request and a dataset. The processor may obtain the data cleaning request and/or the dataset from one or more components of the data cleaning system 100 (e.g., the storage 120) or by interacting with, e.g., the data providing system 130. For example, the data providing system 130 may transmit the dataset and/or the data cleaning request to the data cleaning system 100. In response to the data cleaning request, the data cleaning system 100 may initiate the process 600 to clean the dataset. In some embodiments, a user may specify, through the data providing system 130, one or more parameters for the data cleaning system 100 to perform data cleaning. For instance, a user may specify a desired data size to be used for screening a dataset, a neural network model on the basis of which an identification model is to be constructed and updated based on screened data of a dataset, or the like, or a combination thereof.

The dataset may include multiple groups of image data. The image data may include an image, a video, etc. The image data may include two-dimension image data, three-dimension image data, etc. Each of the multiple groups may include image data of a specific data size. The data size of each of the multiple groups may be same or different. As used herein, the data size of a group may refer to the number of images in the group. Each of the multiple groups may correspond to a subject. As used herein, a subject and a group corresponding to the subject may refer that the image data in the group represent one or more characteristics of the subject. The subject may include a person, an animal, a plant, etc. The characteristics of the subject may be used to distinguish the subject from other subjects. For example, if the subject is a person, the characteristics of the subject may include facial features such as features relating to the ears, the lip, the nose, the eyes, the eyebrows, etc. The image data in each group may be pre-tagged with a label indicating the corresponding subject. In some embodiments, a label may include a specific character, a specific image, or the like, or any combination thereof. Merely for illustration purposes, the label “A” associated with a group may indicate, for example, one or more images in the group correspond to a specific subject “A.”

In 604, the processing device 112 (e.g., the data preprocessing module 420) may preprocessing the dataset. In some embodiments, the preprocessing may include pre-cleaning the dataset. As used herein, the pre-cleaning of the dataset may refer to identifying and removing a fraction of the dataset from the dataset. The identified fraction may include image data that fail to specify at least one characteristic of a subject. For example, the identified fraction may include one or more images in a group of the dataset corresponding to a subject. The noise level in each of the one or more images may exceed a threshold such that the one or more images fail to specify a characteristic of the subject. As used herein, the term “image data” may be used interchangeably with the term “image.”

In some embodiments, the data preprocessing module 420 may identify the fraction of the dataset to be removed based on a preliminary identification model trained based on the dataset. The preliminary identification model may be configured with a preliminary accuracy threshold. As used herein, an accuracy threshold may be used to evaluate an accuracy of an identification model. The greater the accuracy threshold is, the accuracy of the identification model may be. The preliminary accuracy threshold may include a constant value, e.g., below the value of 1 (e.g., 0.1, 0.2, etc.). The preliminary accuracy threshold may be set by a user or according to a default setting of the data cleaning system 100.

In some embodiments, the data preprocessing module 420 may determine a probability that an image in a specific group of the dataset corresponds to the specific subject associated with the specific group using the preliminary identification model. If the data preprocessing module 420 determines that the probability is below the preliminary accuracy threshold, the data preprocessing module 420 may remove the image from the specific group of the dataset. As used herein, the probability that an image corresponds to a subject may be assessed based on a similarity between one or more features represented in the image and the characteristic(s) of the subject. In some embodiments, the processor may obtain the preliminary identification model from one or more components of the data cleaning system 100 (e.g., the storage 120) or by interacting with, e.g., the service providing system 130. For example, the service providing system 130 may transmit the preliminary identification model to the data cleaning system 100.

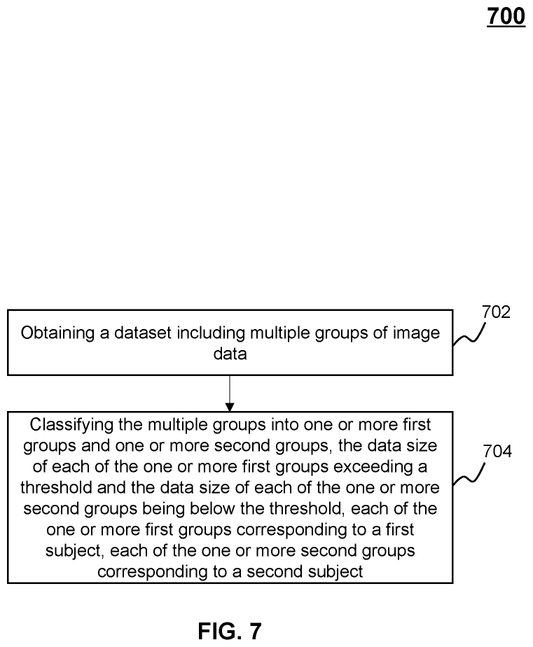

In some embodiments, the preprocessing of the dataset may include classifying the dataset into one or more first groups and one or more second groups according to data size. The data size of each of the first groups may exceed a quantity threshold. The data size of each of the second groups may be lower than the quantity threshold. More descriptions for classifying the dataset according to data size may be found in FIG. 7 and the description thereof. In some embodiments, a group whose data size is equal to the quantity threshold may be designated as a first group. In some embodiments, a group whose data size is equal to the quantity threshold may be designated as a second group.

In 606, the processing device 112 (e.g., the data cleaning module 430) may clean the preprocessed dataset. The processing device 112 may clean the preprocessed dataset by identifying at least one portion of the preprocessed dataset with an inaccurate label and re-classifying the identified portion of the preprocessed dataset with the inaccurate label. For example, an image in a group “A” may be pre-tagged with a label “A” corresponding to a subject “A.” The processing device 112 may determine whether the image is pre-tagged with an inaccurate label based on a probability that the image in the group “A” corresponds to subject “A.” If the probability that the image in the group “A” corresponds to subject “A” is below a threshold, the processing device 112 may determine that the image is pre-tagged with an inaccurate label. If the processing device 112 determines that the probability that the image in the group “A” corresponds to subject “A” below a threshold, the processing device 112 may remove the image from the group “A”. Further, the processing device 112 may classify the image into a group “B” corresponding to a subject “B” if the processing device 112 determines that the probability that the image corresponding to the subject “B” exceeds the threshold.

The processing device 112 (e.g., the acquisition module 410) may clean the preprocessed dataset based on one or more identification models. In some embodiments, the processing device 112 may obtain a first identification model. The first identification model may be configured with a first accuracy threshold. The processing device 112 may classify each of the first groups to generate a first classification result including a first part and a second part using the first identification model. A probability (or referred to as a first probability) that the image data in the first part of a first group corresponds to the subject associated with the first group may be greater than a first threshold. A probability (or referred to as a second probability) that the image data in the second part corresponds to the subject associated with the first group may be lower than the first threshold. The first parts of the first groups may constitute a qualified dataset. The second parts of the first groups may constitute an unqualified dataset.

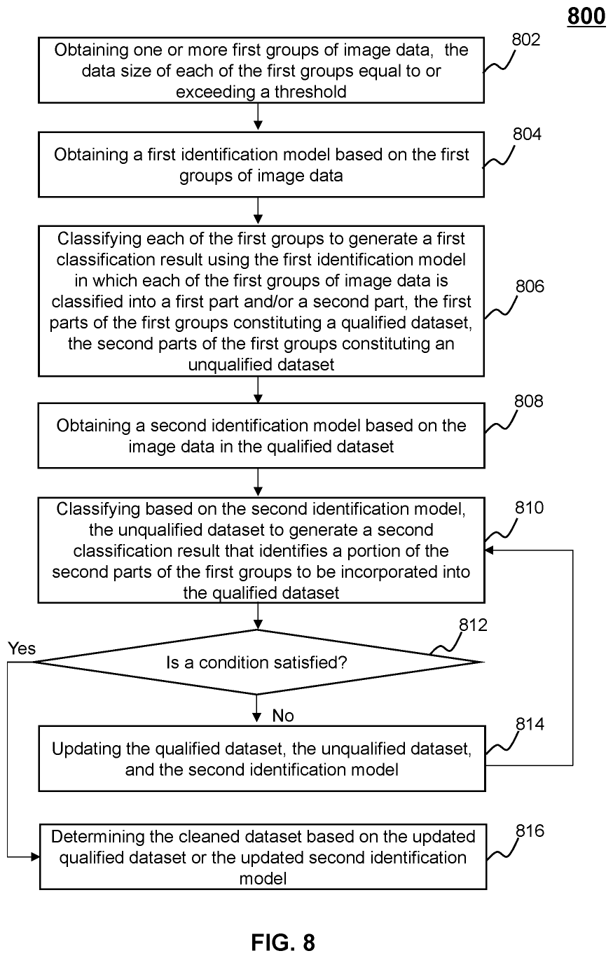

In some embodiments, the processing device 112 may obtain a second identification model. The second identification model may be configured with a second accuracy threshold. The second accuracy threshold may be different from the first accuracy threshold. In some embodiments, the second accuracy threshold may be lower than the first accuracy threshold. In some embodiments, the data cleaning module 430 may further classify the unqualified dataset by performing one or more iterations based on one or more features. The further classification may be achieved in one or more iterations. In each of the one or more iterations, the processing device 112 may classify, based on the second identification model, the image data in the unqualified dataset to generate a second classification result that identifies a portion of the second parts of the first groups to be incorporated into the qualified dataset. The processing device 112 may update the qualified dataset and the unqualified dataset based on the second classification result in each of the one or more iterations. The processing device 112 may further update the second identification model based on the updated qualified dataset. More descriptions for cleaning a dataset may be found in FIG. 8 and the description thereof.

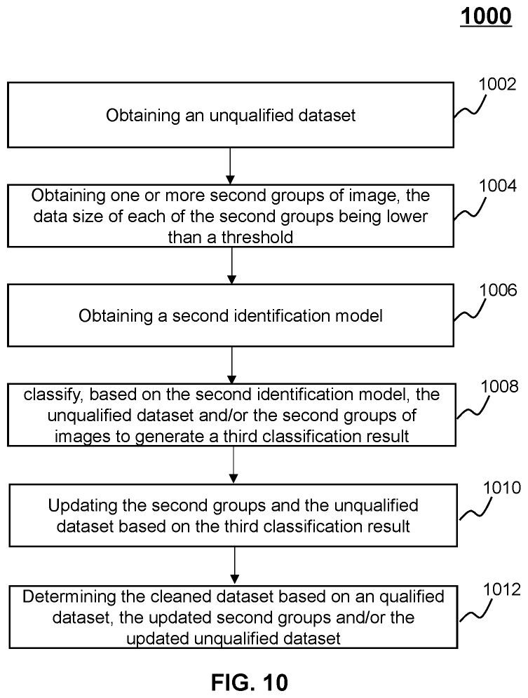

In 608, the processing device 112 (e.g., the data cleaning module 430) may send the cleaned dataset to the data providing system. In some embodiments, the cleaned dataset may be transferred to the service providing system 140. The service providing system 140 may train an identification model using a first portion of the cleaned dataset. The first portion of the cleaned dataset may be also referred as a training dataset. The service providing system 140 may test the trained identification model using a second portion of the cleaned dataset. The second portion of the cleaned dataset may be also referred to as a test dataset. The training dataset may include the qualified dataset. The test dataset may be determined based on the unqualified dataset and/or the one or more second groups according to, e.g., process 1000 as described in FIG. 10.

It should be noted that the above description is merely provided for the purposes of illustration, and not intended to limit the scope of the present disclosure. For persons having ordinary skills in the art, multiple variations and modifications may be made under the teachings of the present disclosure. However, these variations and modifications still remain in the scope of the present disclosure. For example, operation 604 may be omitted from the process 600. As another example, the process 600 may further include storing the cleaned dataset in one or more components of the data cleaning system 100 (e.g., the storage 120).

FIG. 7 is a flowchart illustrating an exemplary process for classifying a dataset based on data size according to some embodiments of the present disclosure. In some embodiments, the process 700 may be implemented in the data cleaning system. For example, the process 700 may be stored in the storage 120 and/or the storage (e.g., the ROM 230, the RAM 240, etc.) as a form of instructions, and invoked and/or executed by the server 110 (e.g., the processing device 112 in the server 110, or the processor 220 of the processing device 112 in the server 110).

In 702, the processing device 112 (e.g., the data preprocessing module 420, etc.) may obtain a dataset, e.g., a pre-cleaned dataset. The dataset may include multiple groups of image data. The image data may include images, videos, or a combination thereof. The image data may include two-dimension image data, three-dimension image data, etc. The processing device 112 may obtain the dataset from one or more components of the data cleaning system (e.g., the storage 120, the pre-processing module 420, etc.) or by interacting with, e.g., the data providing system 130. For example, the data providing system 130 may transmit the dataset (e.g., a pre-cleaned dataset) to the data cleaning system 100. As another example, the preprocessing module 420 may transmit the pre-cleaned dataset to the data cleaning module 420 after pre-cleaning a dataset provided by, for example, the data providing system 130. More descriptions for the pre-cleaned dataset may be found elsewhere in the present disclosure (e.g., FIG. 6 and the descriptions thereof).

In 704, the processing device 112 (e.g., the data cleaning module 430) may classify the multiple groups into one or more first groups and one or more second groups. The data size of each of the one or more first groups may exceed a threshold. The data size of each of the one or more second groups may be below the threshold. Each of the one or more first groups may correspond to a first subject. Each of the one or more second groups may correspond to a second subject. In some embodiments, each of the one or more first groups may include one or more images associated with the first subject. The data size of a first group may refer to the number/count of the one or more images in each of the first group. Each of the one or more second groups may include one or more images associated with the second subject. The data size of a second group may refer to the number/count of the one or more images in the second group.

In some embodiments, the data size determination unit 510 may determine the data size of each group in the dataset. The classification unit 540 may classify the groups in the dataset according to the data size. If the classification unit 540 determines that the data size of a specific group exceeds the threshold, the classification unit 540 may designate the specific group as a first group. If the classification unit 540 determines that the data size of a specific group is below the threshold, the classification unit 540 may designate the specific group as a second group. The threshold may include a constant value (e.g., 100, 1000, etc.). The threshold may be set by a user via a terminal (e.g., a computer) interacting with the data cleaning system 100 or according to a default setting of the data cleaning system 100. For example, the greater the average data size of the multiple groups is, the greater the threshold may be.

It should be noted that the above description is merely provided for the purposes of illustration, and not intended to limit the scope of the present disclosure. For persons having ordinary skills in the art, multiple variations and modifications may be made under the teachings of the present disclosure. However, these variations and modifications still remain in the scope of the present disclosure. For example, a group having the data size equal to the threshold may be classified into the one or more first groups or the one or more second groups. As another example, in 702, the processing device 112 may obtain a dataset as described in connection with 602. The dataset is not pre-cleaned. In 704, the processing device 112 may classify the dataset into one or more first groups and one or more second groups.

FIG. 8 is a flowchart illustrating an exemplary process for classifying at least one portion of a dataset according to some embodiments of the present disclosure. In some embodiments, the process 800 may be implemented in the data cleaning system 100. For example, the process 800 may be stored in the storage 120 and/or the storage (e.g., the ROM 230, the RAM 240, etc.) as a form of instructions, and invoked and/or executed by the server 110 (e.g., the processing device 112 in the server 110, or the processor 220 of the processing device 112 in the server 110).

In 802, the processing device 112 (e.g., the acquisition module 410) may obtain one or more first groups of image data. The data size of each of the one or more first groups may exceed a threshold. A first group may be associated with one or more characteristics of a corresponding first subject. The characteristic(s) of different first subjects corresponding to the first groups may be different. The characteristic(s) of a first subject may be defined by one or more features of the first subject. For example, if the first subject includes a person, the characteristic(s) may be defined by at least one of the facial features (e.g., ears, lips, tongue, eyes, nose, etc.). The image data in a first group may be pre-tagged with a label indicating that the image data in the first groups corresponds to the first subject.

The processing device 112 (e.g., the acquisition module 410) may obtain the one or more first groups from one or more components of the data cleaning system (e.g., the storage 120, the storage module 440, the storage unit 550, the preprocessing module 420, the classification unit 540, etc.) or by interacting with, e.g., the data providing system 130. For example, the classification unit 540 may classify a dataset (e.g., a pre-cleaned dataset) into the one or more first groups and transmit the one or more first groups to the storage unit 550. The acquisition module 410 may obtain the one or more first groups from the storage unit 550. As another example, the data preprocessing module 420 may classify a dataset (e.g., a pre-cleaned dataset) into the one or more first groups and transmit the one or more first groups to the storage module 440. The acquisition module 410 may obtain the one or more first groups from the storage module 440. More descriptions for the first groups of image data may be found elsewhere in the present disclosure (e.g., FIG. 7 and the descriptions thereof).

In 804, the processing device 112 (e.g., the model determination unit 520) may obtain a first identification model based on the first groups of image data. The first identification model may be configured with a first accuracy threshold. The first identification model may be used to determine a probability that the image data in a first group corresponds to the first subject. As used herein, a probability that image data corresponding to a subject may be assessed based on a similarity between one or more features represented in the image data and the characteristic(s) of the subject. The greater the similarity between the one or more features represented in the image data and the characteristic(s) of the subject is, the greater the probability for the image data corresponding to the subject may be. Further, the first identification model may be used to determine whether the image data in a first group belong to a first subject based on the first accuracy threshold. If the probability that the image data in a first group corresponds to a first subject exceeds the first accuracy threshold, it may be determined that the image data belongs to the first subject. If the probability that the image data in a first group corresponds to a first subject is below the first accuracy threshold, it may be determined that the image data do not belong to the first subject. In some embodiments, the first identification model may be further configured to provide the probability that the image data in each of the first groups corresponds to the first subject.

In some embodiments, the first identification model may be generated by training a first pre-determined identification model using the first groups of image data. The first pre-determined identification model may be constructed based on a neural network model. Exemplary pre-determined identification models may include an interactive activation competition (IAC) model, a Bruce-Young model, etc. In some embodiments, the first identification model may be generated by training a first neural network model using the first groups of image data. Exemplary neural network models may include a long short-term memory (LSTM) model, a recurrent neural network (RNN) model, a convolutional neural network (CNN) model, a generative adversative nets (GAN) model, a back propagation neural network (BPNN) model, or the like, or a combination thereof. The processing device 112 (e.g., the model determination unit 520) may obtain the first pre-determined identification model and/or the first neural network model from one or more components of the data cleaning system (e.g., the storage 120, etc.) or by interacting with, e.g., the service providing system 140, etc. For example, the service providing system 140 may transmit the first pre-determined identification model and/or the first neural network model to the model determination unit 520.

In 806, the processing device 112 (e.g., the classification unit 540) may classify each of the first groups of image data based on the first identification model to generate a first classification result. A first group of image data may be classified into a first part and/or a second part. The image data in the first part of a first group may correspond to a first subject with a first probability. The image data in the second part of a first group may correspond to the first subject with a second probability. The first probability may be greater than a first threshold, and the second probability may be lower than the first threshold. The first parts of the first groups may constitute a qualified dataset and the second parts of the first groups may constitute an unqualified dataset.

In some embodiments, the processing device 112 may determine the probability that the image data in a first group correspond to the first subject using the first identification model. The processing device 112 (e.g., the classification unit 540) may classify the image data in a first group whose probability (or referred to as the first probability) exceeds the first accuracy threshold into the first part. The processing device 112 (e.g., the classification unit 540) may classify the image data in a first group whose probability (or referred to as the second probability) is lower than the first accuracy threshold into the second part.

In 808, the processing device 112 (e.g., the model determination unit 520) may obtain a second identification model based on the image data in the qualified dataset. The second identification model may be used to identify and extract one or more features from the image data in the qualified dataset and/or the image data in the unqualified dataset. The second identification model may be configured with a second accuracy threshold. The second accuracy threshold may be different from the first accuracy threshold. In some embodiments, the second accuracy threshold may be below or equal the first accuracy threshold.

In some embodiments, the second identification model may be generated by training the first identification model using the image data in the qualified dataset. In some embodiments, the second identification model may be the same as the first identification model. In some embodiments, the second identification model may be generated by training a second pre-determined identification model or a second neural network using the image data in the qualified dataset. The processing device 112 (e.g., the model determination unit 520) may obtain the second pre-determined identification model and/or the second neural network model from one or more components of the data cleaning system (e.g., the storage 120, etc.) or by interacting with, e.g., the service providing system 140, etc. For example, the service providing system 140 may transmit the second pre-determined identification model and/or the second neural network model to the model determination unit 520. In some embodiments, the second pre-determined identification model may be the same as or different from the first pre-determined identification model. In some embodiments, the second neural network model may be the same as or different from the second neural network model.

In 810, the processing device 112 (e.g., the classification 530) may classify the unqualified dataset to generate a second classification result based on the second identification model. The second classification result may identify a portion of at least one of the second parts of the first groups to be incorporated into the qualified dataset. In some embodiments, the processing device 112 (e.g., the classification 530) may determine whether a portion of the image data in the unqualified dataset based on a third probability that the portion of the image data in the unqualified dataset corresponds to a target first subject and the second accuracy threshold. If the processing device 112 determines that the third probability that the image data of a second part of a first group (or a portion thereof) corresponds to a target first subject exceeds the second accuracy threshold, the processing device 112 may re-classify the image data as belong to a first part of a first group and incorporate the image data originally in the unqualified dataset to the qualified dataset. Further, the processing device 112 may incorporate the re-classified image data into a first part corresponding to the target first subject in the qualified dataset. If the processing device 112 determines that the third probability that the image data of a second part of a first group (or a portion thereof) corresponds to a target first subject is below the second accuracy threshold, the processing device 112 may retain the image data in the unqualified dataset.

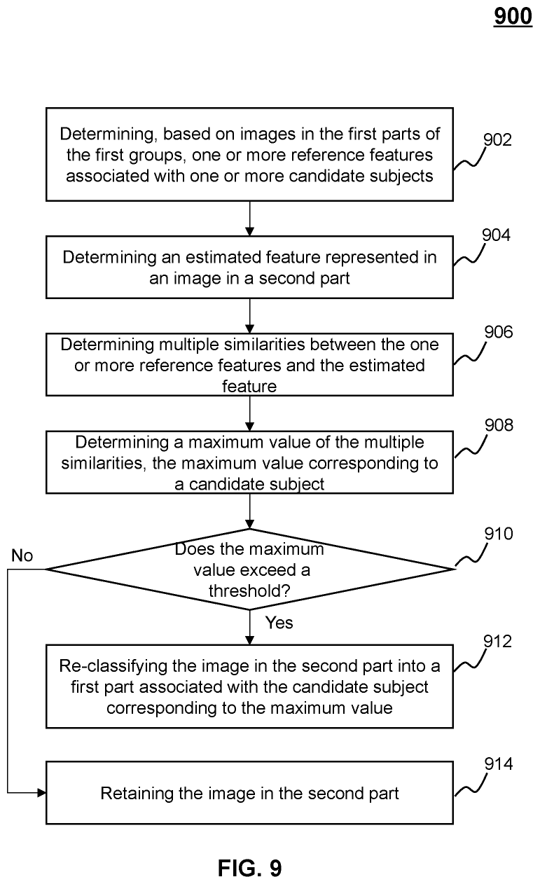

A target first subject corresponding to the image data in a second part of a first group may be identified based on similarities between at least one estimated feature represented in the image data in the second part of the first group and at least one reference feature represented in the image data in the first part of one or more other first groups corresponding to candidate first subjects. The reference feature(s) may be associated with multiple candidate first subjects corresponding to each of the other first groups. For each of the multiple candidate first subjects, a similarity may be determined. The target first subject may correspond to a maximum value of the multiple similarities. In some embodiments, the maximum value of the multiple similarities may be designated as the third probability. More descriptions for classify the image data in the unqualified dataset may be found in FIG. 9 and the description thereof.

In 812, the processing device 112 (e.g., the classification unit 540) may determine whether a condition is satisfied. If the processing device 112 determines that the condition is satisfied, the process 800 may proceed to operation 816. If the processing device 112 determines that the condition is not satisfied, the process 800 may proceed to operation 814. In some embodiments, the condition may relate to an evaluation parameter of the second identification model. Exemplary evaluation parameters of the second identification model may include a false rejection rate (FRR), a false acceptance rate (FAR), an accuracy, or the like, or a combination thereof. For example, the condition may relate to the accuracy of the second identification model. If the processing device 112 determines that the accuracy of the second identification model exceeds the second accuracy threshold, the processing device 112 (e.g., the classification unit 540) may determine that the condition is satisfied. If the processing device 112 determines that the accuracy of the second identification model is below the second accuracy threshold, the processing device 112 (e.g., the classification unit 540) may determine that the condition is not satisfied. The accuracy of the second identification model may be determined based on a test set acquired from an external storage device or database, such as the Labeled Faces in the Wild Home (LFW) face database, the Face Detection Data Set and Benchmark (FDDB) face database, the Helen face database, etc.

In some embodiments, the condition may relate to the iteration count of the iterations performed to classify the unqualified dataset. If the processing device 112 determines that the iteration count exceeds a count threshold, the processing device 112 (e.g., the classification unit 540) may determine that the condition is satisfied. If the processing device 112 determines that the iteration count is below the count threshold, the processing device 112 (e.g., the classification unit 540) may determine that the condition is not satisfied. In some embodiments, the condition may relate the data size of the qualified dataset and/or the unqualified dataset. For example, if the processing device 112 determines that the data size of the qualified dataset exceeds a first quantity threshold and/or the data size of the unqualified dataset is below a second quantity threshold, the processing device 112 (e.g., the classification unit 540) may determine that the condition is satisfied. If the processing device 112 determines that the data size of the qualified dataset is below the first quantity threshold and/or the data size of the unqualified dataset exceeds the second quantity threshold, the processing device 112 (e.g., the classification unit 540) may determine that the condition is not satisfied. The count threshold, the first quantity threshold, and/or the second quantity threshold may be set by a user or according to default settings of the data cleaning system 100.

In 814, the processing device 112 (e.g., the classification unit 540) may update the qualified dataset, the unqualified dataset, and the second identification model. In some embodiments, at least one portion of image data in the second part corresponding to a specific first subject may be classified into the first part corresponding to the specific first subject or another first subject (also referred to as a target first subject). Then the qualified dataset and the unqualified dataset may be updated based on the re-classified image data. The qualified dataset may be expanded by incorporating the re-classified image data. For example, an image corresponding to a first subject “A” in the unqualified dataset may be incorporated into a first part corresponding to a first subject “B” or the first subject “B” in the qualified dataset. The unqualified dataset may be updated by removing the re-classified image data.

In some embodiments, the second identification model obtained in operation 806 may be updated based on the updated qualified dataset. For example, the second identification model obtained in operation 806 may be trained using the updated qualified dataset. As another example, the second identification model obtained in operation 806 may be updated by training the first identification model using the updated qualified dataset.

In 816, the processing device 112 (e.g., the classification unit 540) may determine the cleaned dataset based on the updated qualified dataset and/or the updated second identification model. In some embodiments, the cleaned dataset may include the updated qualified dataset. In some embodiments, the processing device 112 (e.g., the classification unit 540) may further obtain one or more second groups of image data. Each of the second groups may correspond to a second subject. The data size in each of the second groups may be below a threshold. The processing device 112 (e.g., the classification unit 540) may classify the second groups of image data and the unqualified dataset to generate a third classification result based on the updated second identification model. The processing device 112 (e.g., the classification unit 540) may further update the updated qualified dataset, the updated unqualified dataset, and update the second groups based on the third classification result. More descriptions for generating the third classification result may be found in FIG. 10 and the description thereof.

In some embodiments, the processing device 112 (e.g., the classification unit 540) may store the cleaned dataset and/or the updated second identification model in the storage unit 550, the storage 120, etc. In some embodiments, the processing device 112 may transmit the cleaned dataset and/or the updated second identification model to one or more component by interacting with, e.g., the data providing system 130, etc. For example, the processing device 112 may transmit the cleaned dataset to the data providing system 130. As another example, the processing device 112 may transmit the updated second identification model to the service providing system 140.

It should be noted that the above description is merely provided for the purposes of illustration, and not intended to limit the scope of the present disclosure. For persons having ordinary skills in the art, multiple variations and modifications may be made under the teachings of the present disclosure. For example, operation 802 and operation 804 may be integrated into a single operation. As another example, process 800 may further include storing the intermediate data generated in process 800. The intermediate data may include a probability that the image data corresponds to a first subject, the first classification result, the second classification result, the unqualified dataset, the qualified dataset, etc. However, these variations and modifications still remain in the scope of the present disclosure. In some embodiments, if the processing device 112 determines that the accuracy of the second identification model is equal to the second accuracy threshold, the processing device 112 (e.g., the classification unit 540) may determine that the condition is satisfied or not satisfied. In some embodiments, if the processing device 112 determines that the iteration count is equal to the count threshold, the processing device 112 (e.g., the classification unit 540) may determine that the condition is satisfied or not satisfied.

FIG. 9 is a flowchart illustrating an exemplary process for classifying image data based on features according to some embodiments of the present disclosure. In some embodiments, the process 900 may be implemented in the data cleaning system. For example, the process 900 may be stored in the storage 120 and/or the storage (e.g., the ROM 230, the RAM 240, etc.) as a form of instructions, and invoked and/or executed by the server 110 (e.g., the processing device 112 in the server 110, or the processor 220 of the processing device 112 in the server 110). Operation 810 may be performed according to process 900 as described in FIG. 9.

In 902, the processing device 112 (e.g., the feature determination unit 530) may determine one or more reference features associated with one or more candidate subjects based on images in the first parts of the first groups. The images of the first parts of the first groups may constitute a qualified dataset as described elsewhere in the present disclosure (e.g., FIG. 8 and the description thereof). Each of the one or more reference features may be associated with one of the candidate subjects corresponding to one of the first parts. In some embodiments, a reference feature may also be referred to as a reference feature vector associated with a candidate subject.

In some embodiments, the feature determination unit 530 may determine the one or more reference features associated with the one or more candidate subjects using a feature extraction technique. Exemplary feature extraction techniques may include using a scale-invariant feature transform (SIFT) algorithm, a speeded-up robust features (SURF) algorithm, a histogram of oriented gradient (HOG) algorithm, a difference of Gaussian (DOG) algorithm, or the like, or a combination thereof. In some embodiments, the feature determination unit 530 may extract one or more reference features using an identification model (e.g., the first identification model and/or the second identification model as described elsewhere in the present disclosure (e.g., FIG. 8 and the description thereof)).

The feature determination unit 530 may extract a reference feature associated with a candidate subject based on one or more images in the first part corresponding to the candidate subject. In some embodiments, the first part corresponding to the candidate subject may include a plurality of images. Each of the plurality of images may correspond to the candidate subject with a probability. The feature determination unit 530 may extract a reference feature associated with the candidate subject based on the probability that one or more images correspond to the candidate subject. Based on the one or more images of the candidate subject, the feature determination unit 530 may extract the reference feature associated with the candidate subject. In some embodiments, the feature determination unit 530 may determine one of the plurality of images with a maximum probability corresponding to the candidate subject. The feature determination unit 530 may extract the reference feature from the image with the maximum probability. In some embodiments, the feature determination unit 530 may determine at least two of the plurality of images. For example, the feature determination unit 530 may determine the at least two of the plurality of images corresponding to the candidate subject with probabilities greater than a threshold. As another example, the feature determination unit 530 may rank the plurality of images according to probability. Then, the feature determination unit 530 may select a specific number of images from the plurality of images based on their probabilities ranking from high to low. The feature determination unit 530 may further extract a set of reference features from the at least two images. Each of the set of reference features may corresponding to one of the at least two images. The feature determination unit 530 may determine an equalization feature associated with the candidate subject based on the set of reference features. The feature determination unit 530 may designate the equalization feature as the reference feature associated with the candidate subject. As used herein, the equalization feature may refer to an average of the set of reference features.

In 904, the processing device 112 (e.g., the feature determination unit 530) may determine an estimated feature represented in an image in a second part. The images of the second parts may constitute an unqualified dataset as described elsewhere in the present disclosure (e.g., FIG. 8 and the description thereof). In some embodiments, the feature determination unit 530 may determine the estimated feature from the image in the second part using a feature extraction technique as described elsewhere in the present disclosure (e.g., FIG. 9 and relevant descriptions thereof). In some embodiments, the feature determination unit 530 may determine the estimated feature from the image in the second part using an identification model as described elsewhere in the present disclosure (e.g., FIG. 8 and the description thereof). For example, the feature determination unit 530 may determine the estimated feature from the image in the second part using the second identification model. In some embodiments, the feature extraction technique and/or the identification model used to extract the estimated feature may be same as or different from the feature extraction technique and/or the identification model used to extract the reference feature. For example, the feature determination unit 530 may determine the estimated feature and the reference feature using the same second identification model. As another example, the feature determination unit 530 may determine the estimated feature using the scale-invariant feature transform (SIFT) algorithm, and determine the reference feature using the speeded-up robust features (SURF) algorithm.

In 906, the processing device 112 (e.g., the classification unit 540) may determine multiple similarities between the one or more reference features and the estimated feature. In some embodiments, a similarity between the estimated feature and one of the one or more reference features may be defined by a distance between the estimated feature and the one of the one or more reference features. Exemplary distances may include a Eucledian distance, a Manhattan distance, a Minkowski distance, or the like, or a combination thereof. In some embodiments, a similarity between the estimated feature and one of the one or more reference features may be defined by a cosine similarity, a Jaccard similarity, a Pearson correlation coefficient, or the like, or a combination thereof.

In 908, the processing device 112 (e.g., the feature determination unit 530 or the classification unit 540) may determine a maximum value of the multiple similarities. The maximum value may correspond to a candidate subject.

In 910, the processing device 112 (e.g., the classification unit 540) may determine whether the maximum value exceeds a threshold. If the processing device 112 determines that the maximum value exceeds the threshold, the processing device 112 may proceed to operation 912. If the processing device 112 determines that the maximum value is below the threshold, the processing device 112 may proceed to operation 914. The threshold may be a value, e.g., a constant value below 1, for example, 0.8, 0.85, 0.9, 0.95, 0.98, etc. The threshold may be set by a user or according to a default setting of the data cleaning system 100.

In 912, the processing device 112 (e.g., the classification unit 540) may re-classify the image in the second part into a first part associated with the candidate subject corresponding to the maximum value. If the maximum value of the similarities between the estimated feature and a reference feature associated with the candidate subject exceeds the threshold, the processing device 112 may designate the candidate subject corresponding to the maximum value as a target subject corresponding to the image. The processing device 112 (e.g., the classification unit 540) may re-classify the image in the second part into the first part associated with the target subject. In other words, the image in the unqualified dataset may be assigned or incorporated into the qualified dataset.

In 914, the processing device 112 (e.g., the classification unit 540) may retain the image in the second part. If the maximum value of the similarities between the estimated feature and a reference feature associated with the candidate subject is below the threshold, the processing device 112 may not re-classify the image to qualified database. Then, the image may be retained in the second part. In other words, the image may be still deemed belonging to the unqualified dataset.

It should be noted that the above description is merely provided for the purposes of illustration, and not intended to limit the scope of the present disclosure. For persons having ordinary skills in the art, multiple variations and modifications may be made under the teachings of the present disclosure. In some embodiments, operation 902 and operation 904 may be integrated into a single operation. In some embodiments, if the maximum value of the similarities between the estimated feature and the reference feature associated with the candidate subject equals the threshold, the processing device 112 may assign the image in the second part into the first part associates with the target subject or retain the image in the second part.

FIG. 10 is a flowchart illustrating an exemplary process for classifying at least one portion of a dataset according to some embodiments of the present disclosure. In some embodiments, the process 1000 may be implemented in the data cleaning system. For example, the process 1000 may be stored in the storage 120 and/or the storage (e.g., the ROM 230, the RAM 240, etc.) as a form of instructions, and invoked and/or executed by the server 110 (e.g., the processing device 112 in the server 110, or the processor 220 of the processing device 112 in the server 110).

In 1002, the processing device 112 (e.g., the acquisition unit 410) may obtain an unqualified dataset. The unqualified dataset may include multiple sets of images of the first groups each of whose data size exceeds a threshold. Each of the multiple sets of images may be associated with a first subject. Images in each of multiple sets may be pre-tagged with a label corresponding to the second subject.

The processing device 112 may obtain the unqualified dataset from one or more components in the data cleaning system 100. For example, the processing device 112 may obtain the unqualified dataset from the storage 120, the storage module 440, the storage unit 550, etc. More descriptions for determining the unqualified dataset may be found in FIG. 8 and the description thereof. For example, the unqualified dataset may include the updated unqualified dataset determined after one or more of iterations are performed and the condition is satisfied as described with reference to FIG. 8.

In 1004, the processing device 112 (e.g., the acquisition unit 410) may obtain one or more second groups of images. The data size of each of the second groups may be lower than a threshold. The second groups of image data may be determined according to process 700 as described in FIG. 7. Each of the second groups may correspond to a second subject. Images in each of the second groups may be pre-tagged with a label corresponding to the second subject. The processing device 112 may obtain the one or more second groups of images from one or more components in the data cleaning system 100. For example, the processing device 112 may obtain the one or more second groups of images from the storage 120, the storage module 440, the storage unit 550, etc.

In 1006, the processing device 112 (e.g., the classification unit 540) may obtain a second identification model. The second identification model may be configured to extract one or more features from the images in the unqualified dataset and/or the images in the one or more second groups. The processing device 112 may obtain the second identification model from one or more components in the data cleaning system 100. For example, the processing device 112 may obtain the second identification model from the storage 120, the storage module 440, the storage unit 550, etc. More descriptions for determining the second identification model may be found in FIG. 8 and the description thereof. For example, the second identification model may include the updated second identification model determined after a plurality of iterations are performed and the condition is satisfied as described with reference to FIG. 8.

In 1008, the processing device 112 (e.g., the classification unit 540) may classify the unqualified dataset and/or the second groups to generate a third classification result based on the second identification model. The third classification result may identify a portion of the unqualified dataset to be incorporated into at least one of the second groups or a portion of the second groups of images to be incorporated into the unqualified dataset.

In some embodiments, for an image of a first part in the unqualified dataset, the processing device 112 may determine an estimated feature associated with the first subject based on the second identification model. The processing device 112 may further determine multiple reference features associated with multiple second subjects based on one or more images in the second groups. The processing device 112 may determine multiple similarities between the estimated feature and the reference features associated with multiple second subjects. The processing device 112 may determine a maximum value of the multiple similarities. The maximum value of the multiple similarities may correspond to one of the multiple second subjects (also referred to as a target second subject) and one of the second groups (also referred to as a target second group). If the processing device 112 determines that the maximum value exceeds a similarity threshold, the processing device 112 may re-classify the image from the unqualified dataset into the target second group corresponding to the target second subject. The image incorporated into the target second group may be tagged with a label corresponding to the target second subject. If the processing device 112 determines that the maximum value is below the similarity threshold, the processing device 112 may retain the image in the unqualified dataset.

In some embodiments, for an image of a second subject in the second groups, the processing device 112 may determine an estimated feature associated with the second subject based on the second identification model. The processing device 112 may further determine reference features associated with multiple first subjects based one or more images of the multiple first subjects in the unqualified dataset. The processing device 112 may determine multiple similarities between the estimated feature associated with the second subject and the reference features associated with the multiple first subjects. The processing device 112 may determine a maximum value of the multiple similarities. The maximum value of the multiple similarities may correspond to one of the multiple first subjects (also referred to as a target first subject) and one of the multiple sets of images of the multiple first subjects in the unqualified dataset (also referred to as a target first set). If the processing device 112 determines that the maximum value exceeds the similarity threshold, the processing device 112 may re-classify the image from the second groups into the target first set corresponding to the target first subject. The image incorporated into the target first set may be tagged with a label corresponding to the target first subject. If the processing device 112 determines that the maximum value is below the similarity threshold, the processing device 112 may retain the image in the second groups.

In 1010, the processing device 112 (e.g., the classification unit 540) may update the second groups and/or the unqualified dataset based on the third classification result. In some embodiments, one or more images in the unqualified dataset may be incorporated into at least one of the second groups. For example, an image associated with a first subject “A” in the unqualified dataset may be incorporated into a second group corresponding to a second subject “B”. In some embodiments, one or more images in the second groups may be incorporated into the unqualified dataset. For example, an image associated with a second subject “C” in the second groups may be incorporated into a set in the unqualified dataset corresponding to a first subject “D”.

In 1012, the processing device 112 (e.g., the classification unit 540) may determine a cleaned dataset based on the updated second groups, the updated unqualified dataset, and a qualified dataset. More descriptions for determining the qualified dataset may be found in FIG. 8 and the description thereof. For example, the qualified dataset may include the updated qualified dataset determined after one or more of iterations are performed and a condition is satisfied as described in FIG. 8. In some embodiments, the cleaned dataset may include the qualified dataset and the updated unqualified dataset. For example, if one or more images in the second groups are incorporated into the unqualified dataset based on the third classification result, the updated second groups of image data may be removed from a dataset (e.g., the pre-cleaned dataset as described in FIG. 6). The cleaned dataset may include the qualified dataset and the updated unqualified dataset.

In some embodiments, the cleaned dataset may include the qualified dataset and the updated second groups. For example, if one or more images in the unqualified dataset may be incorporated into at least one of the second groups, the updated unqualified dataset may be removed from a dataset. The cleaned dataset may include the qualified dataset and the updated second groups. In some embodiments, the qualified dataset may be used as a training dataset in a subsequent model training. In some embodiments, the unqualified dataset may be used as a test dataset in a subsequent model testing.

It should be noted that the above description is merely provided for the purposes of illustration, and not intended to limit the scope of the present disclosure. For persons having ordinary skills in the art, multiple variations and modifications may be made under the teachings of the present disclosure. For example, operation 1008 and operation 1010 may be integrated into one single operation.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “module,” “unit,” “component,” “device,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claim subject matter lie in less than all features of a single foregoing disclosed embodiment.

1. A system for interacting with a data providing system and a service providing system, comprising:
a data exchange port of the system to receive one or more datasets from the data providing system and one or more identification models from the service providing system;
a data transmitting port of the system connected to the data providing system and the service providing system for conducting content identification;
one or more storage devices including one or more sets of instructions for data cleaning;
one or more processors in communication with the data exchange port, the data transmitting port, and the one or more storage devices, wherein when executing the one or more set of instructions, the one or more processors:
obtain a data cleaning request and a dataset from the data providing system, the dataset including multiple groups of image data;
in response to the data cleaning request of the data providing system:
determine first groups of image data from the multiple groups, each of the first groups of image data associated with a characteristic of a first subject;
obtain, based on the first groups of image data, a first identification model configured with a first accuracy threshold;
classify, based on the first identification model, the first groups of image data to generate a first classification result in which each of the first groups of image data is classified into a first part and/or a second part, wherein image data in the first part corresponds to the first subject with a first probability greater than the first accuracy threshold, and image data in the second part corresponds to the first subject with a second probability lower than the first accuracy threshold, the first parts of the first groups constituting a qualified dataset, the second parts of the first groups constituting an unqualified dataset;
obtain, based on the image data in the qualified dataset, an initial second identification model with a second accuracy threshold;
in each of one or more iterations,
classify, based on a second identification model, the unqualified dataset to generate a second classification result that identifies a portion of the second parts of the first groups to be incorporated into the qualified dataset, the second identification model being the initial second identification model or an updated second identification model determined in a prior iteration;
update the qualified dataset and the unqualified dataset based on the second classification result; and
update, based on the updated qualified dataset, the second identification model; and
determine a cleaned dataset based on the updated qualified dataset or the updated second identification model to be provided to the data providing system.

2. The system of claim 1, the one or more processors further:
obtain a third identification model from the service providing system;
identify, based on the third identification model, a fraction of the dataset to be removed, the identified fraction including image data that fail to specify the characteristic of a first subject; and
pre-clean the dataset based on the third identification model by removing the identified fraction of the dataset.

3. The system of claim 1, wherein a data size of each of the one or more first groups exceeds a first threshold.

4. The system of claim 1, wherein to obtain, based on the first groups of image data, a first identification model configured with a first accuracy threshold, the one or more processors:
generate the first identification model by training a fourth identification model using the first groups of image data.

5. The system of claim 4, wherein the fourth identification model is constructed based on a neural network model.

6. The system of claim 1, wherein to obtain, based on the image data in the first part, an initial second identification model with a second accuracy threshold, the one or more processors:
generate the initial second identification model by training the first identification model using the qualified dataset.

7. The system of claim 1, wherein to classify, based on a second identification model, the unqualified dataset to generate a second classification result that identifies a portion of the second parts of the first groups to be incorporated into the qualified dataset, the one or more processors:
determine, based on the second identification model, whether a third probability that the image data in the second part of a first group corresponds to a target first subject exceeds the second accuracy threshold.

8. The system of claim 7, wherein to determine, based on the second identification model, whether a third probability that the image data in the second part of a first group corresponds to a target first subject exceeds the second accuracy threshold, the one or more processors:
determine, based on the second identification model, an estimated feature represented in the image data in the second part, the estimated feature being associated with the characteristic of the first subject;
determine, based on the second identification model, a reference feature associated with each of one or more candidate first subjects, the reference feature being associated with the characteristic of the first subject;
determine, based on the estimated feature and the one or more reference features, the target first subject from the one or more candidate first subjects;
determine the third probability; and
compare the third probability with the second accuracy threshold.

9. The system of claim 8, wherein to determine one or more reference features associated with one or more candidate first subjects, the one or more processors:
for each of the one or more candidates first subject,
determine, based one or more images in the first part of the each candidate first subject, a set of features associated with the each candidate first subject using the second identification model;
determine an equalization feature based on the set of features; and
designate the equalization feature as the reference feature associated with the each candidate first subject.

10. The system of claim 8, wherein to determine whether a third probability that the image data in the second part of a first group corresponds to the target first subject exceeds the third threshold, the one or more processors:
determine a similarity between the reference feature and the target first subject;
determine whether the similarity exceeds a second threshold; and
determine that the third probability exceeds the second accuracy threshold if the similarity exceeds the second threshold.

11. The system of claim 7, wherein to classify, based on the second identification model, the unqualified dataset to generate a second classification result that identifies a portion of the second parts of the first groups to be incorporated into the qualified dataset, the one or more processors:
for each second part of the second parts of the first groups
determine, based on the second identification model, the third probability that the image data in the second part of a first group corresponds to a target first subject exceeds the second accuracy threshold; and
in response to a determination that the third probability of the second part exceeds the second accuracy threshold, incorporate the image data in the second part into the first part of the first group corresponding to the target first subject.

12. The system of claim 7, wherein to classify, based on the second identification model, the unqualified dataset to generate a second classification result that identifies a portion of the second parts of the first groups to be incorporated into the qualified dataset, the one or more processors:
for each second part of the second parts of the first groups
determine, based on the second identification model, that the third probability that the image data in the second part of a first group corresponds to a target first subject is below the second accuracy threshold; and
in response to a determination that the third probability of the second part is below the second accuracy threshold, retain the image data in the second part in the unqualified dataset.

13. The system of claim 1, wherein the one or more processors further:
determine one or more second groups from the multiple groups, a data size of each of the one or more second groups being below a third threshold, each of the one or more second groups being associated with a second subject;
classify, based on the updated second identification model, the updated unqualified dataset to generate a third classification result that identifies a portion of the unqualified dataset to be incorporated into the second groups;
update, based on the third classification result, the one or more second groups; and
determine the cleaned dataset including the qualified dataset and the updated second groups.

14. A method for interacting with a data providing system and a service providing system, the method implemented on a computing device having at least one processor and at least one computer-readable storage medium, the method comprising:
obtaining a data cleaning request and a dataset from the data providing system, the dataset including multiple groups of image data;
in response to the data cleaning request of the data providing system:
determining first groups of image data from the multiple groups, each of the first groups of image data associated with a characteristic of a first subject;
obtaining, based on the first groups of image data, a first identification model configured with a first accuracy threshold;
classifying, based on the first identification model, the first groups of image data to generate a first classification result in which each of the first groups of image data is classified into a first part and/or a second part, wherein image data in the first part corresponds to a first subject with a first probability greater than the first accuracy threshold, and image data in the second part corresponds to the first subject with a second probability lower than the first accuracy threshold, the first parts of the first groups constituting a qualified dataset, the second parts of the first groups constituting an unqualified dataset;
obtaining, based on the image data in the qualified dataset, an initial second identification model with a second accuracy threshold;
in each of one or more iterations
classifying, based on a second identification model, the unqualified dataset to generate a second classification result that identifies a portion of the second parts of the first groups to be incorporated into the qualified dataset, the second identification model being the initial second identification model or an updated second identification model determined in a prior iteration;
updating the qualified dataset and the unqualified dataset based on the second classification result; and
updating, based on the updated qualified dataset, the second identification model; and
determining a cleaned dataset based on the updated qualified dataset or the updated second identification model to be provided to the data providing system.

15. The method of claim 14, further comprising:
obtaining a third identification model from the service providing system;
identifying, based on the third identification model, a fraction of the dataset to be removed, the identified fraction including image data that fail to specify the characteristic of a first subject; and
pre-cleaning the dataset based on the third identification model by removing the identified fraction of the dataset.

16. The method of claim 14, wherein obtaining, based on the first groups of image data, a first identification model with a first accuracy threshold further includes:
generating the first identification model by training a fourth identification model using the first groups of image data.

17. The method of claim 14, wherein obtaining, based on the image data in the first part, an initial second identification model with a second accuracy threshold includes:
generating the initial second identification model by training the first identification model using the qualified dataset.

18. The method of claim 14, wherein classifying, based on a second identification model, the unqualified dataset to generate a second classification result that identifies a portion of the second parts of the first groups to be incorporated into the qualified dataset includes:
determining, based on the second identification model, whether a third probability that the image data in the second part of a first group corresponds to a target first subject exceeds the second accuracy threshold.

19. The method of claim 14, further comprising:
determining one or more second groups from the multiple groups, a data size of each of the one or more second groups being below a fifth threshold, each of the one or more second groups being associated with a second subject;
classifying, based on the updated second identification model, the updated unqualified dataset to generate a third classification result that identifies a portion of the unqualified dataset to be incorporated into the second groups;
updating, based on the third classification result, the one or more second groups; and
determining the cleaned dataset including the qualified dataset and the updated second groups.

20. A non-transitory computer readable medium, comprising at least one set of instructions for interacting with a data providing system and a service providing system, wherein when executed by one or more processors of a computing device, the at least one set of instructions causes the computing device to perform a method, the method comprising:
obtaining a data cleaning request and a dataset from the data providing system, the dataset including multiple groups of image data;
in response to the data cleaning request of the data providing system:
determining first groups of image data from the multiple groups, each of the first groups of image data associated with a characteristic of a first subject;
obtaining, based on the first groups of image data, a first identification model configured with a first accuracy threshold;
classifying, based on the first identification model, the first groups of image data to generate a first classification result in which each of the first groups of image data is classified into a first part and/or a second part, wherein image data in the first part corresponds to a first subject with a first probability greater than the first accuracy threshold, and image data in the second part corresponds to the first subject with a second probability lower than the first accuracy threshold, the first parts of the first groups constituting a qualified dataset, the second parts of the first groups constituting an unqualified dataset;
obtaining, based on the image data in the qualified dataset, an initial second identification model with a second accuracy threshold;
in each of one or more iterations
classifying, based on a second identification model, the unqualified dataset to generate a second classification result that identifies a portion of the second parts of the first groups to be incorporated into the qualified dataset, the second identification model being the initial second identification model or an updated second identification model determined in a prior iteration;
updating the qualified dataset and the unqualified dataset based on the second classification result; and
updating, based on the updated qualified dataset, the second identification model; and
determining a cleaned dataset based on the updated qualified dataset or the updated second identification model to be provided to the data providing system.
